(19) United States
(12) Patent Application Publication
(10) Pub. No.: US 2011/0135841 A1
(43) Pub. Date: Jun. 9, 2011

(54) APPARATUS AND METHOD FOR DEPOSITING AND CURING FLOWABLE MATERIAL

(75) Inventor: Henk Thijssen, Singapore (SG)

(73) Assignee: GSLBU SINGAPORE PTE LTD., Singapore (SG)

(21) Appl. No.: 12/991,151

(22) PCT Filed: May 5, 2008
(86) PCT No.: PCT/SG08/00163

§ 371 Date: Jan. 26, 2011

(51) Int. Cl. B05D 3/02; B05C 9/14; B05D 1/00; B05C 11/00; B05D 3/06

(52) U.S. Cl. 427/558; 118/642; 427/532

(57) ABSTRACT

An apparatus for depositing and curing a curable material on a substrate comprising a deposition means configured to deposit the curable material on the substrate along a deposition path, and a light source configured to direct a beam of light on the deposited curable material to thereby at least partially cure the curable material and thereby prevent it from substantially deforming in shape.

### TECHNICAL FIELD

The present invention generally relates to an apparatus and method thereof for depositing and curing flowable material.

### BACKGROUND

The continuous development of new devices has led to new product requirements that can be achieved by the integration of existing materials to meet the specific needs of such devices. One of the most common material combinations involves the integration of polymers on a solid substrate. Conventionally, solid polymers are integrated on a solid substrate by attaching die-cut polymers onto the solid substrate by means of an adhesive. However, this conventional method poses several problems including the loss of adhesiveness of the polymers on the solid substrate over time and the arduous task of ensuring each solid polymer is customarily shaped to specifically fit the shape of each solid substrate.

The abovementioned problems become more apparent in large scale manufacturing industries, such as the hard-disk industries, which require high production efficiencies as well as good adhesion between the polymer and the solid substrate. In the hard disk industry the polymer acts as a sealant on the hard-disk devices' cover to prevent dust and gases such as water vapor from entering and interfering with the sensitive magnetic heads contained within the confines of the covers, as well as shielding the sensitive magnetic components from magnetic interferences. The use of pressure sensitive adhesive and/or an adhesive to attach the polymer to the covers undesirably stains the hard-disk covers and leads to the generation of dust inside the hard disk device. Furthermore, the use of die-cut polymers results in the generation of waste sheets that cannot be utilized, leading to production wastage and an unnecessary rise in production costs.

Photocurable liquid polymers have been increasingly utilized in place of solid polymers. In such processes, the photocurable liquid polymer is first dispensed on the solid substrate along a desired path, before it is cured under intense photo-irradiation. In hard-disk industry, the polymer sealant formed in this manner are known as “Formed-in-Place-Gaskets” (FIPG).

In FIPG production processes where photocurable liquid polymers are used, it is of vital importance that a certain degree of the chemical crossing-linking of the liquid polymer (curing) is done very shortly after they have been dispensed. This is necessary as the aspect ratio of the dispensed polymerizable material to form the polymer gasket has tight tolerances. Hence, the dispensed polymerizable material which will be used to form the polymer gasket needs to be conserved in substantially its exact shape at the time of dispensation. If there is a time delay between the dispensation of the polymerizable material and the curing step, the aspect ratio of the gasket formed after polymerization will change, mainly depending on the viscosity of the liquid polymer and the ambient temperature. This is commonly known as “slumping” of the liquid polymer.

Generally for gaskets with a thickness of more than a few hundred microns, this small amount of chemical cross-linking of the liquid polymer (fast curing) cannot provide enough energy to create an instantaneous through cure of the material. Therefore this process of fast-curing, known as “spot-curing”, solely intends to preserve the aspect ratio and avoid slumping. The spot cured gasket is then treated in another location to undergo a subsequent high intensity UV curing step to complete curing of the material.

Known spot-cure systems make use of flood-light systems, being applied during the dispensing of the material and irradiating the whole work-area. This has a number of disadvantages, including the detrimental effect it has on dispensing tubes and electrical wiring (especially so if an ultraviolet light source is used) and the need to shield the nozzle from the irradiating light source. This shielding typically only minimizes direct irradiation, but is unable to block off multiple reflections from the work piece, which can still have a negative effect on the liquid polymer where it leaves the nozzle.

Furthermore, an uneven curing dose is provided to different parts of the gasket being dispensed because the longest curing time for the polymer occurs at the section of the gasket where the dispensing starts while the shortest curing time occurs at the section of the gasket where dispensing ends. As the position of the flood-light systems are also usually fixed, the straight line distance from the flood-light systems to various parts of the gasket also differs, contributing to the uneven curing intensity. These differences in curing exposure time and intensity for different parts of the gasket may result in uneven mechanical properties being present in the formed gasket (i.e. level of solidification and degradation), which is not desirable.

As the flood-light systems are usually situated at a distance from the work-piece to ensure that a large area of irradiation is covered, there may be shadowing effects caused by the movement of the equipment present in the path of the flood-light systems' irradiation during the dispensing operation, thereby preventing various parts of the gasket from having an adequate exposure to radiation.

In addition, due to the fact that the flood-light systems do not have a focused beam (but have a dispersed light source instead), they have to be switched on at high power and/or for long periods of time to ensure sufficient curing. This results in a large amount of electricity being expended. From an economical perspective, this undesirably increases the operating costs.

There is a need to provide an apparatus and method thereof for depositing and curing flowable material that overcome, or at least ameliorate, one or more of the disadvantages described above.

### SUMMARY OF INVENTION

According to a first aspect, there is provided an apparatus for depositing and curing a curable material on a substrate comprising:

deposition means configured to deposit the curable material on the substrate along a deposition path; and

a light source configured to direct a beam of light on the deposited curable material to thereby at least partially cure the curable material and thereby prevent it from substantially deforming in shape.

Advantageously, the light source is able to partially cure the curable material before any undesired slumping of the material occurs and the desired aspect ratio of the dispensed material is preserved. More advantageously, the partially cured material has sufficient solidification to resist any unwanted deformation when the partially cured polymer is being transferred to another source of higher intensity radiation.

In one embodiment, said curing occurs from about 100 ms to about 200 ms after the deposition of material. Advantageously, this short time frame prevents the curable material from any unwanted slumping.

Yet advantageously, the speed of depositing and curing of the curable material is 40 mm/s or more.

In another embodiment, the light source is capable of rotating at least partially around said deposition means as it travels along said deposition path. Advantageously, the light source is able to negotiate corners and bends to thereby cure any deposited material before slumping occurs.

According to a second aspect of the invention, there is provided a method for depositing and curing a curable material on a substrate comprising the steps of:

depositing the curable material on the substrate along a deposition path; and

directing a beam of light on the deposited curable material to thereby at least partially cure the curable material and thereby prevent it from substantially deforming in shape.

Advantageously, the disclosed method is capable of preventing any undesired slumping of the material from occurring and is also able to preserve the desired aspect ratio of the dispensed material.

According to a third aspect of the invention, there is provided a use of the apparatus according to the first aspect for making form-in-place-gaskets on a substrate. Advantageously, the disclosed apparatus may be used in industries such as the hard-disk devices industry where a high level of production of gaskets is carried out on a regular basis.

### DEFINITIONS

The following words and terms used herein shall have the meaning indicated:

The term “curable material” as used herein refers to any material that may be toughened or hardened by cross-linking of polymer chains. The material may be a polymer and the toughening or hardening may be brought about by a chemical additives, ultraviolet radiation, electron beam or heat.

The term “light source,” as used herein, generally refers to any source of light that is capable of providing radiant energy suitable for curing the curable material. A light source may include, for example, but is not limited to an individual LED or an LED array.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

Exemplary, non-limiting embodiments of an apparatus and method for depositing and curing flowable material, will now be disclosed.

The apparatus comprises a deposition means configured to deposit the curable material on the substrate along a deposition path. A light source is also provided and is configured to direct a beam of light on the deposited curable material while the curable material is being deposited on the deposition path to thereby at least partially cure the curable material to prevent it from substantially deforming in shape.

For embodiments where the deposited curable material has a dimension of height and width when viewed in cross-section, the curing is undertaken such that the extent of the change in the aspect ratio of the deposited curable material is less than 20% or less than 10% or less than 5% or less than 1%.

In one embodiment, the deposition means is capable of dispensing one type of flowable material, wherein said flowable material is a curable material. In one embodiment, the deposition means is an electrically actuated extruder. The deposition means may be actuated to dispense said material mechanically or pneumatically.

In another embodiment, the deposition means is capable of dispensing more than one type of flowable material, wherein said more than one type of flowable material, when combined, form a curable material. The deposition means may comprise a plurality of nozzles for dispensing one or more type of flowable material onto the substrate. In one embodiment, the deposition means comprise eight nozzles.

The plurality of nozzles may be detachable from the dispensing end of the extruder. Advantageously, the detachable nozzle facilitates cleaning of the nozzle.

The curable material may be selected from the group consisting of at least one of an acrylate, silicone elastomer, polyurethane foam, polyester, elastomer, epoxy resin, epoxide and vinyl ether. Exemplary acrylates include polyether acrylates, polyether methacrylates, polyurethane acrylates, polyurethane methacrylates, polyester acrylates, and methacrylates. In a preferred embodiment, the curable material is QAN-TX09 acrylate.

The curable material may also comprise an initiator compound. The initiator compound may be selected from the group consisting at least one of a benzophenone, benzoin ether, benzilketal, α-hydroxyalkylphenone, α-aminoalkylphenone, acylphosphine photoinitiator, isopropylthioxanthone, ethyl 4-(dimethylamino)benzoate, 2-ethylhexyl, methylaminobenzoate, sulfonium, sulfoxonium, iodonium salts and compounds comprising methanone. Advantageously, the initiator compound is thermally stable at the operating temperatures employed. In one embodiment, the curable material may be cured by photo-radiation having at least 200 nm. In another embodiment, the curable material may be cured by photo-radiation having wavelengths in the range of from about 2×10⁻⁷ meters to about 1×10⁻³ meters, from about 2×10⁻⁷ meters to about 0.5×10⁻⁶ meters, from about 0.5×10⁻⁶ meters to about 1×10⁻⁵ meters and from about 1×10⁻⁵ meters to about 1×10⁻³ meters. Advantageously, the curable material may be cured at a wavelength that is compatible with the desired speed of curing, non-detrimental to the curable components and nearby machinery and non-hazardous to operator safety. In one embodiment, the curable material is cured by ultraviolet (UV) light.

The curable material may be at least partially or completely cured by exposing the curable material to energy from a light source.

In one embodiment, the light source is emitted from one or more optical fibers to transfer the photoradiation energy to the appropriate point. The light source may be selected from the group consisting of at least one of a metal-halide, UV, UV LED or infra red. In one embodiment, the light source is an ultraviolet light emitting source. In another embodiment, the UV emitting source is a Hamamatsu UV LED source or Locktite UV LED source.

The focal point and intensity of the light source may be adjusted through the use of elliptical, parabolic, or other shaped reflectors, which may be a metallic, dichromic, or other material.

In one embodiment, the intensity of the light source is from about 0.01 W/cm² to about 10 W/cm².

The light source may comprise a lens for focusing the light in a parallel or slightly converging beam onto the curable material.

The light source may further comprise a cooling system to prevent over heating. The light source may also comprise selectable light filters. Advantageously, this allows for varying of the wavelength and light energy to enable the curing of the different types of curable materials.

In one embodiment, the light source is capable of following the deposition path of the deposition means. Advantageously, the light source is moved by the deposition means to follow the deposition path such that said curing the curable material occurs no more than 1 second or no more than 500 ms, or no more than 300 ms or no more than 200 ms or no more than 100 ms or from about 100 ms to about 200 ms after said deposition of the curable material.

The light source may be coupled to the deposition means or may exist as a decoupled unit from the deposition means. In one embodiment, the displacement between the deposition means and the light source is less than about 1 cm.

In another embodiment, light source is capable of rotating at least partially around said deposition means as it travels along said deposition path. The light source may be capable of moving in at least one axial direction, or between one up to four axial directions, relative to a longitudinal axis on which the deposition means is located. Hence, movement of the light source from one up to four axial direction relative to the deposition means is possible as the deposition means travels along the deposition path. Advantageously, the light source is capable of moving in up to four axial directions relative to the deposition means. For example, the four axial directions may include any one of the parameters of X, Y, Z Cartesian Coordinate system and/or any one of the parameters of r, θ, φ of the spherical coordinate system. The light source may be able to rotate in the clockwise and anti-clockwise direction. The light source is able to rotate from and angle of about −360° to an angle of about 360°. The axis of rotation may be about the deposition means. The ability of the light source to move from one up to four axial direction relative to the deposition means enables it to consistently follow the deposition path to ensure the fast curing of the curable material to prevent the curable material from substantially deforming in shape. This particular ability of the light source to move from one up to four axial direction relative to the deposition means is useful when the deposition path is not linear. For example, when there is a 90 degree change in direction of the deposition path (around corners), the light source is capable of advantageously following the non-linear deposition path by rotating about the deposition means over an angle of 90 degree.

In one embodiment, the light source is able to rotate about the deposition means at a speed of about 4 rpm to about 180 rpm.

Photo-sensor controls may be utilized to maintain the light source intensity. Fluorescent active optical sensors, or other sensors such as filtered photo diode sensors may be utilized to sense the photo-radiation.

The substrate may be a polymer, metal, alloy or a composite. In one embodiment, the substrate is a group IIIA metal or metal alloy. In another embodiment, the substrate is an aluminum or an aluminum alloy.

The deposition means and light source may be coupled to a transport means such as a track on which said material receptacle is capable of traveling along. The track is configured to allow said deposition means and light source to move in a three-dimensional space relative to its starting point, wherein the three dimensional space can be respectively defined by X, Y and Z Cartesian coordinate points. For example, the said material receptacle may move in a circular, spiral, zigzag, vertical, horizontal, diagonal or irregular path along the track. In one embodiment, the track is configured to allow the deposition means and light source to travel in at least one of a substantially vertical direction and a substantially horizontal direction relative to the substrate. In another embodiment, the track is configured to allow said deposition means and light source to travel in a direction normal to said vertical direction. The track may be fixed or may be movable.

In one embodiment, the apparatus comprises a moveable engaging means for moveable coupling of said deposition means and light source along said track. In one embodiment the moveable engaging means comprises an arm coupling to the deposition means and light source and one or more rollers capable of moving along said track. The arm of the engaging means may be an interconnecting set of links and joints moving with one or more degrees of freedom that can perform repetitious tasks involving manipulation and movement. Advantageously, the arm of the engaging means is able to couple firmly with the deposition means and light source without damaging them.

In one embodiment, the apparatus further comprises a motor to move said deposition means and light source along said track. In another embodiment, the motor is actuated by a control means.

The movement of said deposition means and light source along said transport means, deposition and curing of said curable material on said substrate during each operation may be carried out according to predetermined instructions programmed into said control means.

The control means may incorporate a processor capable of interrogating a memory having predetermined instructors for moving and operating said material receptacle. The control means may be linked to a user interface, such as a keyboard, and a graphical user interface such as a LCD display for allowing an operator to interact with the control means.

In one embodiment, the control means comprises a memory having a computer algorithm thereon for storing said predetermined instructions.

The control means may control the deposition means and light source to deposit and cure the curable material on specific locations of the substrate by controlling the movements of the tracks or the movement of engaging means along the tracks. The control means may also control the timing, duration and amount of curable material deposited during each deposition. The control means may also control the movement of the arm of the engaging means, tracks and intensity of the light energy emitted by the light source.

Advantageously the deposition output is controlled by the control means. Various algorithms can be used in order to control the dispensing output. The system may use a predetermined program setting values as a starting point and over time these settings can be customized according to the user's requirements.

Advantageously, the control means has a learning ability to allow it to call on prior knowledge or memory to apply instantaneous settings. This learning ability is preferably encoded by software. The prior knowledge, or stored history, is based on past events, including deposition rates and deposition periods, and is stored in a temporary memory over a period of time. The dispensing system itself may be monitored remotely by a hard wired communication link to the control means, or by radio communications or by means of a portable data log off.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIGS. 1A-1H are schematic diagrams from a top view of a dispensing and curing system in accordance with one embodiment disclosed herein.

### DETAILED DESCRIPTION

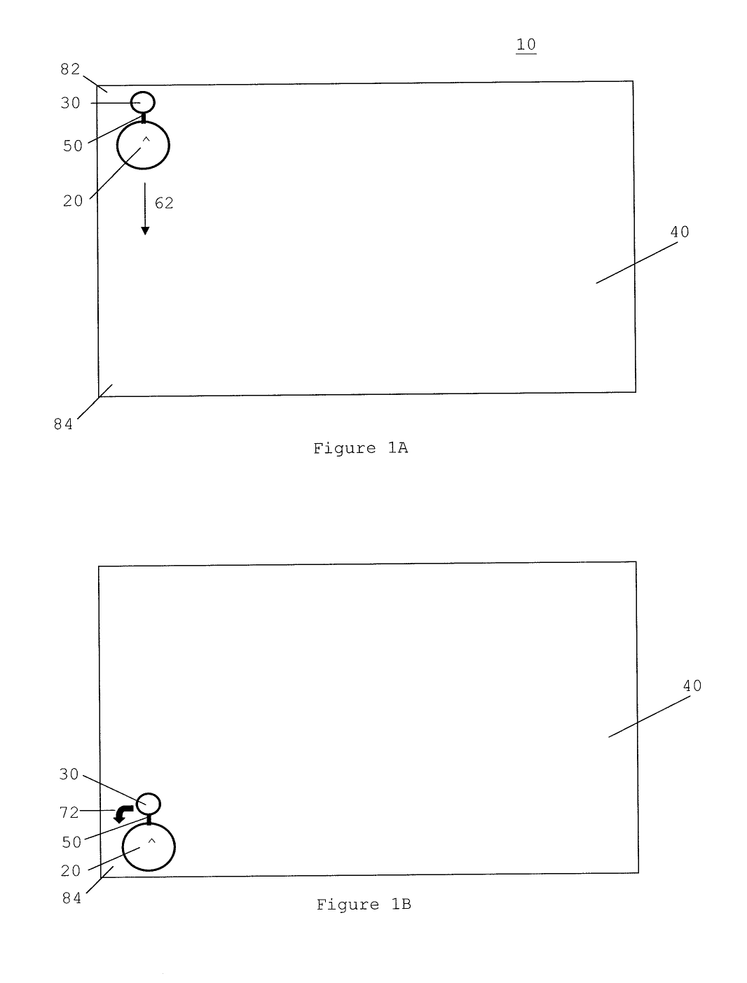

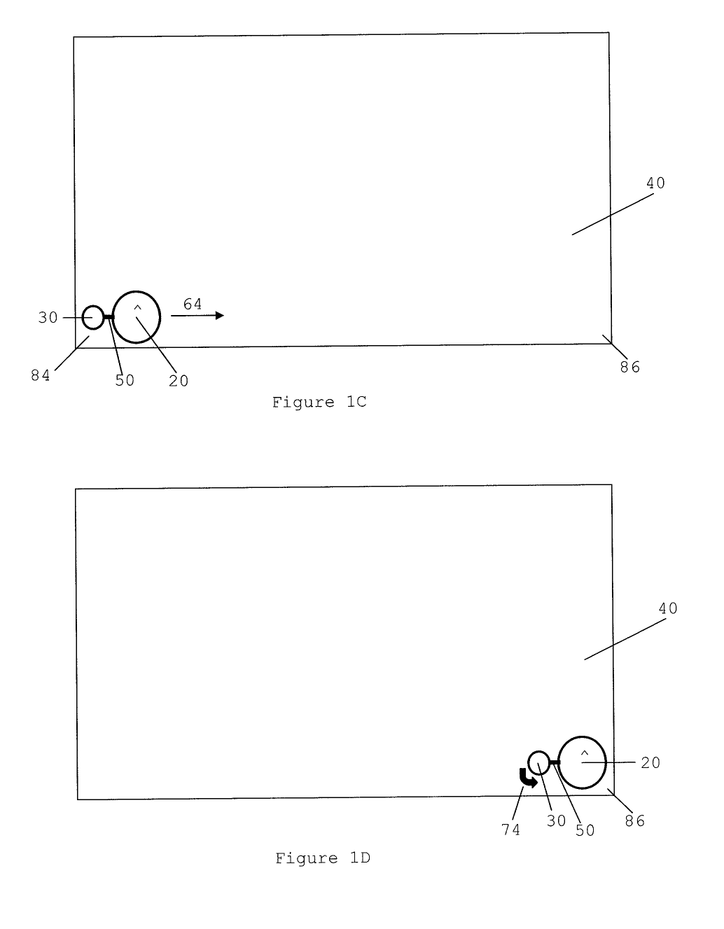

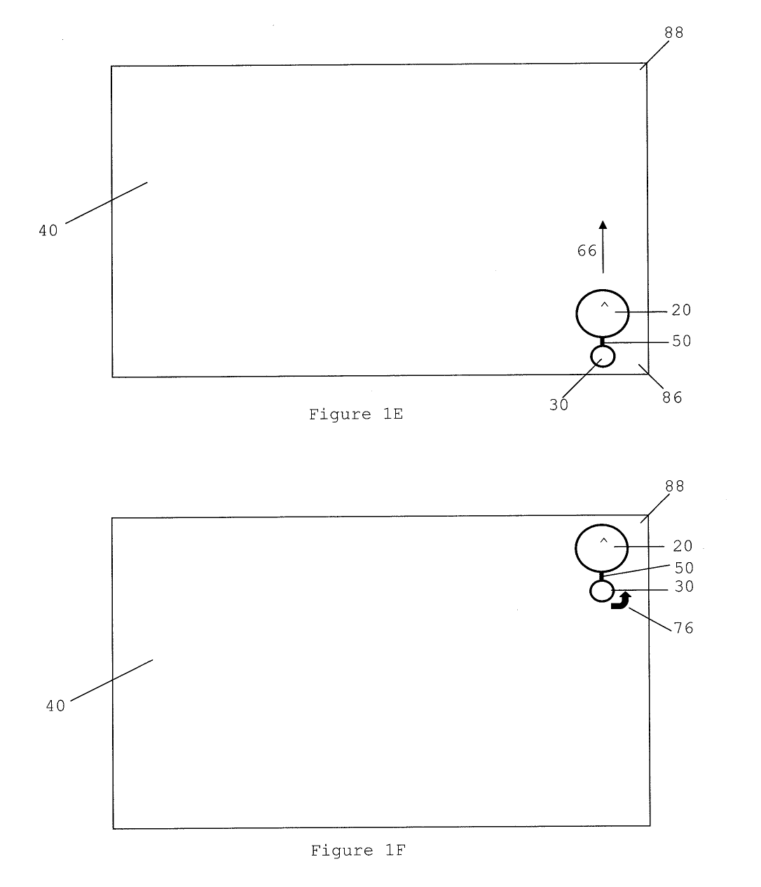

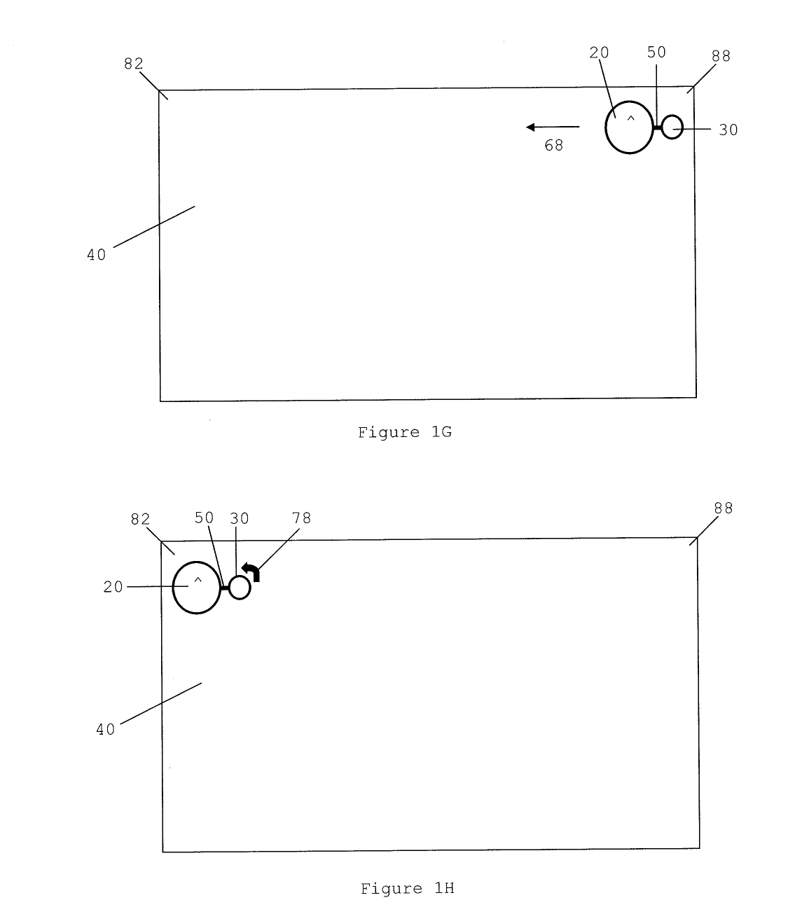

There is shown in FIGS. 1A-1H, a dispensing and curing system 10 comprising a dispenser 20 and a ultraviolet (UV) light source 30 for dispensing curable material onto an aluminum substrate 40.

The dispenser 20 is positioned overhead the aluminum substrate 40 and is capable of dispensing a constant flow of curable material while moving substantially along a deposition path in the form of the perimeter of the aluminum substrate 40 which is rectangular in shape. When in operation, the dispenser 20 moves along the perimeter of the aluminum substrate 40 and thereby disposes the curable material onto the aluminum substrate 40 by gravitational effects, that is, onto the aluminum substrate 40 at a position directly below the dispenser 20.

When in operation, the UV light source 30 moves along the perimeter of the aluminum substrate 40 together with the dispenser 20. The UV light source 30 is connected to the dispenser 20 via a rotational axis 50. When in operation, the UV light source 30 produces a beam of light that shines on and thereby cures the deposited curable material at substantially the same time the curable material is deposited on the aluminum substrate 40.

The rotational axis 50 allows the UV light source 30 to rotate on an axis about the dispenser 20. When in operation, the rotational axis 50 enables the rotational movement of the UV light source 30 about the dispenser 20 such that the UV light source 30 can be re-positioned so that the UV light source 30 is in a position that is behind the dispenser 20 relative to the direction of movement of the dispenser 20.

FIG. 1A shows the dispenser 20 positioned at the first corner 82 of the aluminum substrate 40. The dispenser 20, while dispensing the curable material, moves along one side of the perimeter of the aluminum substrate 40 from the first corner 82 to the second corner 84 in the direction as shown by arrow 62. As shown in FIG. 1A, the UV light source 30 is positioned behind the dispenser 20 with respect to the direction 62 that the dispenser 20 is moving.

FIG. 1B shows the dispenser 20 at the second corner 84 of the aluminum substrate 40, after having moved from the first corner 82. Upon reaching the second corner 82, the dispenser 20 changes its direction of movement by 90 degree in a clockwise direction so that it is able to continue dispensing the curable material along the perimeter of the aluminum substrate 40. The UV light source 30 is rotated about the axis 50 in a clockwise direction as shown by arrow 72 over an angle of 90 degree.

FIG. 1C shows the UV light source 30 that has been re-positioned to behind the dispenser 20 while the dispenser 20 continues dispensing the curable material as it moves from the second corner 84 to the third corner 86 in the direction as shown by arrow 64. The re-positioning of the UV light source 30 is such that the UV light source 30 is positioned just behind the dispenser 20, relative to the direction of movement of the dispenser 20. This ensures that the beam of light shining out of the UV light source 30 is directed at substantially the same time as the curing material is deposited onto the aluminum substrate 40.

FIG. 1D shows the dispenser 20 upon reaching the third corner 86 of the aluminum substrate 40. Similarly as described above, the dispenser 20 changes its direction of movement by 90 degree in the clockwise direction while it continues dispensing the curable material. At the same time, the UV light source 30 rotates about the axis 50 in the clockwise direction 74 over an angle of 90 degree.

As shown in FIG. 1E, the UV light source 30 has re-positioned to a position such that it is directly behind the dispenser 20 as it moves from the third corner 86 to the fourth corner 88 of the aluminum substrate in the direction as shown by arrow 66. Once the UV light source 30 has been re-positioned, as shown in FIG. 1E, the dispenser 20 continues dispensing the curable material as it moves in the direction 66.

FIG. 1F shows the dispenser 20 having reached the fourth corner 88. Similarly as described above, at the fourth corner 88, the dispenser 20 changes its direction of movement by 90 degree in the clockwise direction as it continues dispensing the curable material, while the UV light source 30 rotates about axis 50 in a clockwise direction as shown by arrow 76 over an angle of 90 degree.

As shown in FIG. 1G, after the re-positioning of the UV light source 30 to a position such that it is directly behind the dispenser 20 as it moves back to the first corner 82 from the fourth corner 88 in the direction as shown by arrow 68, the dispenser 20 continues dispensing of the curable material as it moves in the direction 68.

FIG. 1H shows the dispenser 20 having returned to the first corner 82 after dispensing the curable material along the perimeter of the aluminum substrate 40 while curing the curable material at substantially the same time as the curable material is deposited onto the aluminum substrate 40. Upon returning to the first corner 82, the dispenser 20 stops dispensing the curable material and the UV light source 30 rotates about the axis 50 in a clockwise direction as shown by arrow 78 over at angle of 90 degree such that the UV light source 30 is returned to its initial position as shown in FIG. 1A. When in operation, the dispenser 20 may continue dispensing and curing the curable material on the same aluminum substrate 40 for a second round so as to dispense and cure a second layer of the curable material on top of the previously dispensed and cured layer of the curable material on the aluminum substrate 40, following the same procedure as described in FIGS. 1A-1H above.

Upon completion of the second round of dispensing and curing of the curable material on the aluminum substrate 40, the aluminum substrate 40 can then be removed from the system and another aluminum substrate can be placed in the system for the dispensing and curing of the curable material on this other aluminum substrate.

### APPLICATIONS

It will be appreciated that the apparatus and method for depositing and curing a curable material on a substrate is an efficient and useful apparatus and method for depositing and partially curing a curable material before any undesired slumping of the material occurs and that the desired aspect ratio of the dispensed material is substantially preserved.

The apparatus and method disclosed herein enables a liquid curable material to be dispensed on a solid substrate. Advantageously, the use of a liquid curable material removes the need to use die-cut materials. This reduces production wastage and unnecessary increases in production costs.

Furthermore, as the disclosed apparatus and method does not make use of flood-light systems, the detrimental effects on dispensing tubes and electrical wiring that are usually caused by flood lights are reduced. In addition, since the disclosed apparatus and method involves directing a beam of light directly on the deposited curable material, there is no need to provide a shield for the nozzle from the irradiating light source.

Advantageously, as the light source is directed on the deposited curable material and not on other parts of the substrate, reflections of the irradiation from the substrate is subsequently reduced.

More advantageously, the disclosed apparatus and method ensures that a substantially even curing dose and intensity is provided to different parts of the deposited material. This prevents an uneven distribution of mechanical properties achieved for the various parts of deposited material, caused by unequal curing times and intensity.

Moreover, as the light source is purposefully constructed to direct a beam of light to the curable material, there are no equipments or objects obstructing the path of the beam of light. Advantageously, this removes the problems of shadowing, which is a bugbear of known systems.

In addition, due to the fact that the disclosed light source concentrates a beam of light (higher light intensity) to the deposited curable material the time required to partially cure the deposited curable material may be substantially lesser than that required for a flood light system. In this regard, a relatively lesser amount of electricity may be expended as compared to a flood light system (notably when an LED lightsource is used), thereby advantageously reducing the operating costs.

While reasonable efforts have been employed to describe equivalent embodiments of the present invention, it will be apparent to the person skilled in the art after reading the foregoing disclosure, that various other modifications and adaptations of the invention may be made therein without departing from the spirit and scope of the invention and it is intended that all such modifications and adaptations come within the scope of the appended claims.

1. An apparatus for depositing and curing a curable material on a substrate comprising:
deposition means configured to deposit the curable material on the substrate along a deposition path; and
a light source configured to direct a beam of light on the deposited curable material to thereby at least partially cure the curable material and thereby prevent it from substantially deforming in shape,
wherein said light source is capable of rotating at least partially around said deposition means as it travels along said deposition path.

2. The apparatus of claim 1 wherein said curing occurs no more than 500 ms after said deposition of the curable material.

3. The apparatus of claim 2 wherein said curing occurs no more than 300 ms after said deposition of the curable material.

4. The apparatus of claim 3 wherein said curing occurs from about 100 ms to about 200 ms after said deposition of the curable material.

5. The apparatus of claim 1 wherein said deposition means is an electrically actuated extruder.

6. The apparatus of claim 1 wherein said light source is capable of moving in at least two axial directions.

7. The apparatus of claim 6 wherein said light source is capable of moving in four axial directions.

8. The apparatus of claim 1 wherein said light source is an ultraviolet light emitting source.

9. The apparatus of claim 1 wherein said substrate is a metal or a metal alloy.

10. The apparatus of claim 9 wherein said substrate is a group IIIA metal or metal alloy.

11. The apparatus of claim 10 wherein said substrate is aluminum or aluminum alloy.

12. A method for depositing and curing a curable material on a substrate comprising the steps of:
depositing the curable material on the substrate along a deposition path from a deposition means;
directing a beam of light from a light source on the deposited curable material to thereby at least partially cure the curable material and thereby prevent it from substantially deforming in shape; and
at least partially rotating said light source around said deposition means as it travels along said deposition path.

13. The method of claim 12 wherein said directing step occurs no more than 500 ms after said depositing step.

14. The method of claim 13 wherein said directing step occurs no more than 300 ms after said depositing step.

15. The method of claim 14 wherein said directing step occurs from about 100 ms to about 200 ms after said depositing step.

16. The method of claim 12 wherein said depositing step is carried out by an electrically actuated extruder.

17. The method of claim 12 wherein said beam of light is ultraviolet light.

18. The method of claim 12 wherein said substrate is a metal or a metal alloy.

19. The method of claim 18 wherein said substrate is a group IIIA metal or metal alloy.

20. The method of claim 19 wherein said substrate is aluminum or aluminum alloy.

21. (canceled)
